(19) United States
(12) Patent Application Publication
(10) Pub. No.: US 2025/0388107 A1
(43) Pub. Date: Dec. 25, 2025

(54) POWER DISTRIBUTION METHOD AND APPARATUS, DEVICE, AND STORAGE MEDIUM

(71) Applicant: Autel Digital Power Co., Ltd., Shenzhen (CN)

(72) Inventors: Xinhang WAN, Shenzhen (CN); Ke CHEN, Shenzhen (CN); Wenhan LAN, Shenzhen (CN)

(73) Assignee: Autel Digital Power Co., Ltd., Shenzhen (CN)

(21) Appl. No.: 19/304,365

(22) Filed: Aug. 19, 2025

Related U.S. Application Data
(63) Continuation of application No. PCT/CN2024/073611, filed on Jan. 23, 2024.

(30) Foreign Application Priority Data
Feb. 22, 2023 (CN) 202310190024.7

(51) Int. Cl. B60L 53/60; H02J 7/00

(52) U.S. Cl. CPC B60L 53/60; H02J 7/00032; H02J 7/0013; H02J 7/0071

(57) ABSTRACT

A power distribution method includes: acquiring a charging demand of a target charging terminal, wherein the target charging terminal is connected with a first direct-current bus which is any direct-current bus in a charging device; and in a case where power provided by a power assembly that has been switched into the first direct-current bus does not satisfy the charging demand, if a directly connected power assembly of the first direct-current bus has been switched in, switching a first power assembly into the first direct-current bus, wherein the directly connected power assembly is directly connected with the first direct-current bus, the first power assembly is one power assembly which has not yet been switched in, and the first power assembly is connected to the directly connected power assembly and has a smallest distance to the directly connected power assembly.

### CROSS-REFERENCE TO RELATED APPLICATIONS

This application is a continuation of PCT Patent Application No. PCT/CN2024/073611, filed on Jan. 23, 2024, which claims priority to Chinese Patent Application No. 202310190024.7, filed on Feb. 22, 2023. The entire disclosures of each of the aforementioned applications are incorporated herein by reference in their entirety and for all purposes.

### TECHNICAL FIELD

The present disclosure relates to the field of charging, and more particularly relates to a power distribution method and apparatus, a device, and a storage medium.

### BACKGROUND

A new energy vehicle refers to a vehicle which adopts a non-conventional vehicle fuel as a power source. The new energy vehicle which takes electric energy as the power source is called an electric vehicle. A charger is a charging device which is produced to meet a charging demand of the electric vehicle.

The function of the charger is similar to that of a fuel dispenser in a gas station, and the charger is installed in a public building, a residential parking lot or a charging station and can charge the electric vehicles of various models. An input end of the charger is directly connected to an alternating-current power grid, and an output end thereof is provided with a charging gun for charging the electric vehicle. The charger provided with a plurality of charging guns may charge a plurality of electric vehicles simultaneously. Since different electric vehicles have different rated powers, the output power of the charging guns is adjusted by the charger according to the rated powers of the electric vehicles, so that the charging efficiency may be improved. In order to improve the charging efficiency, how to dynamically distribute the power to the charging guns becomes a problem which needs to be solved urgently.

### SUMMARY

The present disclosure provides a power distribution method and apparatus, a device, and a storage medium, so as to solve at least the technical problem of dynamic power distribution for charging guns.

In a first aspect, provided is a power distribution method, which is applied to a charging device, wherein the charging device includes a plurality of power assemblies, the plurality of power assemblies are connected to form a power assembly topology, a fling-cut switch is used for connecting two adjacent power assemblies, a distance between any two power assemblies in the plurality of power assemblies is equal to the number of fling-cut switches between the any two power assemblies, and some or all of the plurality of power assemblies are connected with a direct-current bus in the charging device; and the method includes:
acquiring a charging demand of a target charging terminal, the target charging terminal being connected with a first direct-current bus, and the first direct-current bus being any direct-current bus in the charging device; and
in a case where power provided by a power assembly which has been switched into the first direct-current bus does not satisfy the charging demand, in response to determining that a directly connected power assembly of the first direct-current bus has been switched in, switching a first power assembly into the first direct-current bus, where the directly connected power assembly is directly connected with the first direct-current bus, the first power assembly is a power assembly which has not yet been switched in, the first power assembly is capable of being connected to the directly connected power assembly and is a power assembly which has a smallest distance to the directly connected power assembly, and a distance between the plurality of power assemblies and the directly connected power assembly is measured by the number of fling-cut switches connected between the plurality of power assemblies and the directly connected power assembly.

In one embodiment of the present disclosure, after the charging demand of the charging terminal connected with the direct-current bus is acquired, in the case where the power provided by the power assembly which has been switched into the direct-current bus does not satisfy the charging demand of the charging terminal connected with the direct-current bus, if the directly connected power assembly connected with the direct-current bus has been switched in, the power assembly closest to the directly connected power assembly is switched into the direct-current bus, so as to distribute the power assembly to the charging terminal connected with the direct-current bus for use and achieve dynamic distribution of the power, so that output power of the charging terminal can meet the charging demand; power assemblies in the charging device are connected to form the power assembly topology, the fling-cut switch is used for connecting two adjacent power assemblies, the distance between the power assemblies and the directly connected power assembly is measured by the number of the fling-cut switches connected between the power assemblies and the directly connected power assembly, and the power assembly closest to the directly connected power assembly is distributed to the charging terminal for use, which is essentially distributing the nearby power assembly to the charging terminal according to the hierarchy of a topology structure formed by the power assemblies, so that the charging terminal not only has the output power which can satisfy the charging demand, but also can be applicable to the power assembly topology formed by various connection modes, with high applicability.

In a second aspect, provided is a power distribution apparatus, which is applied to a charging device, where the charging device includes a plurality of power assemblies, the plurality of power assemblies are connected to form a power assembly topology, a fling-cut switch is used for connecting two adjacent power assemblies, a distance between any two power assemblies in the plurality of power assemblies is equal to the number of fling-cut switches between the any two power assemblies, and some or all of the plurality of power assemblies are connected with a direct-current bus in the charging device; and the apparatus includes:
a demand acquirer, used for acquiring a charging demand of a target charging terminal, where the target charging terminal is connected with a first direct-current bus, and the first direct-current bus is any direct-current bus in the charging device; and
a distributor, used for: in a case where power provided by a power assembly which has been switched into the first direct-current bus does not satisfy the charging demand, in response to determining that a directly connected power assembly of the first direct-current bus has been switched in, switching a first power assembly into the first direct-current bus, where the directly connected power assembly is directly connected with the first direct-current bus, the first power assembly is a power assembly which has not yet been switched in, the first power assembly is connected to the directly connected power assembly and is a power assembly which has a smallest distance to the directly connected power assembly, and a distance between the power assemblies and the directly connected power assembly is measured by the number of fling-cut switches connected between the power assemblies and the directly connected power assembly.

In a third aspect, provided is a computer device, including a memory, a charging terminal, and one or more processors, where the memory and the charging terminal are connected to the one or more processors, the one or more processors are used for executing one or more computer programs stored in the memory, and the one or more processors, when executing the one or more computer programs, cause the computer device to implement the power distribution method in the first aspect described above.

In a fourth aspect, provided is a non-transitory computer-readable storage medium, having a computer program stored thereon, where the computer program includes program instructions which, when executed by a processor, cause the above processor to execute the power distribution method in the first aspect described above.

In a fifth aspect, provided is a charging device, including a plurality of power assemblies, where the plurality of power assemblies are connected to form a power assembly topology, a fling-cut switch is used for connecting two adjacent power assemblies, a distance between any two power assemblies in the plurality of power assemblies is equal to the number of fling-cut switches between the any two power assemblies, some or all of the plurality of power assemblies are connected with a direct-current bus in the charging device, and the charging device is used for executing the power distribution method in the first aspect.

### BRIEF DESCRIPTION OF DRAWINGS

One or more embodiments are illustrated by way of example in the accompanying drawings which correspond to and are not to be construed as limiting the embodiments, in which elements/modules and steps having the same reference numeral designations represent like elements/modules and steps throughout, and in which the drawings are not to be construed as limiting in scale unless otherwise specified.

FIG. 1 is a schematic connection diagram of a charging system according to an embodiment of the present disclosure;

FIG. 2 is a schematic connection diagram of power assemblies in a charging device according to an embodiment of the present disclosure;

FIG. 3 is a schematic flow diagram of a power distribution method according to an embodiment of the present disclosure;

FIG. 4 is a schematic flow diagram of another power distribution method according to an embodiment of the present disclosure;

FIG. 5 is a schematic structural diagram of a power distribution apparatus according to an embodiment of the present disclosure; and

FIG. 6 is a schematic structural diagram of a computer device according to an embodiment of the present disclosure.

### DETAILED DESCRIPTION

The embodiments of the present disclosure will be described below in conjunction with the accompanying drawings in the embodiments of the present disclosure.

The present disclosure is applicable to a charging scenario, and specifically applicable to a scenario where a multi-gun charger charges one or more electric vehicles, where the multi-gun charger refers to a charger having a plurality of charging guns, the charging gun refers to a charging mechanism which may be directly connected with a charging interface of the electric vehicle to charge the electric vehicle, the charging gun is connected with a direct-current bus in the charger, and the direct-current bus refers to a position where the charging gun is connected.

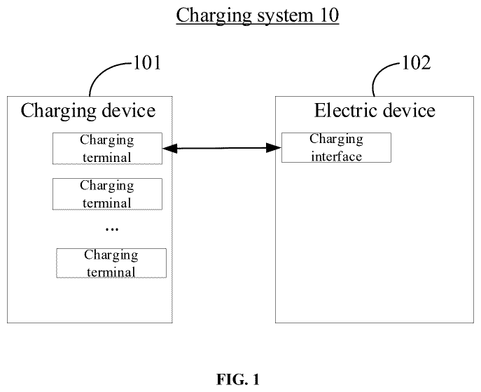

FIG. 1 is a schematic connection diagram of a charging system according to an embodiment of the present disclosure. As shown in FIG. 1, the charging system 10 includes a charging device 101 and one or more electric devices 102, where the charging device 101 is used for charging the electric device 102, and the electric device 102 is internally provided with a battery system used for storing electric energy charged by the charging device 101.

The charging device 101 may contain a plurality of charging terminals, one charging terminal may be used for being connected with a charging interface of one electric device 102 to charge the electric device 102. The charging device 101 further has a plurality of power assemblies therein, the power assemblies may be understood as charging assemblies disposed in the charging device 101, and the power assembly may be connected to the charging terminal through a fling-cut switch to provide the charging terminal with the electric energy required by the electric device 102. The charging device 101 may be a multi-gun charger, a multi-gun charging pile, and the like, and the charging terminal may be a charging gun in the multi-gun charger. The electric device 102 may be the electric vehicle.

In the process of the charging terminal charging the electric device, a charging demand of the charging terminal is determined based on charging rated power of the electric device, and in order to satisfy the charging rated power of the electric device, the power assembly matching the charging demand of the charging terminal needs to be distributed to the charging terminal for use, so that the output power of the charging terminal matches the charging rated power of the electric device, thereby improving the charging efficiency. When the charging device simultaneously charges a plurality of electric devices respectively through a plurality of charging terminals, the respective charging rated power of the plurality of electric devices may be different. In order to simultaneously satisfy the charging demands of the plurality of electric devices, it is necessary to respectively distribute the power assembly matching the charging demand of each charging terminal to each charging terminal according to the charging demands, so that the output power of each charging terminal matches the charging rated power of each electric device.

Thus, the present disclosure provides a power distribution method which may satisfy charging demands of one or more electric terminals in a charging device. The disclosed method may be implemented in the charging device 101 shown in FIG. 1.

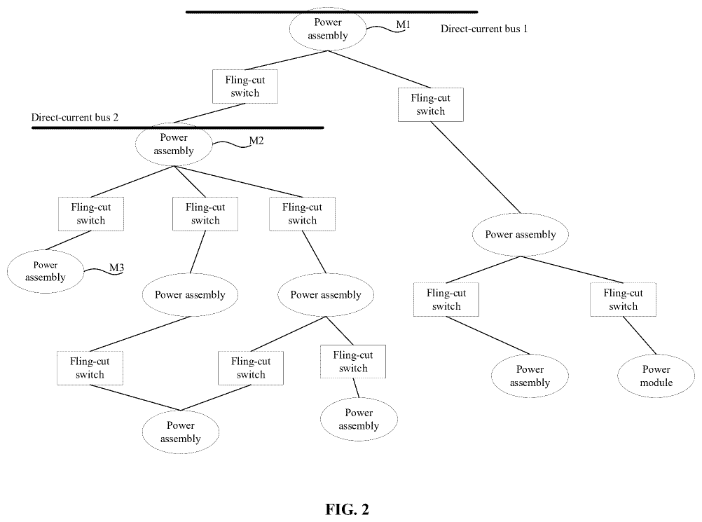

In order to facilitate understanding, a description of a related structure of the charging device of the present disclosure will be firstly given. FIG. 2 is a schematic connection diagram of power assemblies in a charging device provided in the present disclosure. As shown in FIG. 2, the charging device 101 includes a plurality of power assemblies, where the plurality of power assemblies are connected to form a power assembly topology, and each power assembly is abstracted as a node in the power assembly topology, namely, one topological node in the power assembly topology is one power assembly. A fling-cut switch is used for connecting two adjacent power assemblies, and the fling-cut switch is abstracted as a connecting line in the power assembly topology, namely, one connecting line in the power assembly topology is one fling-cut switch. The fling-cut switch is a control relay which may also be referred to as a high-voltage direct-current contactor. An electrical connection may be established between two adjacent power assemblies at two ends of the connecting line corresponding to the fling-cut switch by turning on the fling-cut switch, and the electrical connection therebetween may be cut off by turning off the fling-cut switch.

The connection between various power assemblies in the power assembly topology may be direct connection, and may also be indirect connection, where the direct connection between the power assemblies means that the two power assemblies are connected only through the fling-cut switch, without being spaced by other power assemblies, the number of the fling-cut switches between the two power assemblies which are directly connected is 1, and the number of the power assemblies spaced between the two power assemblies which are directly connected is 0. Illustratively, the power assembly M1 and the power assembly M2 in FIG. 2 are two power assemblies which are directly connected. The indirect connection between the power assemblies means that the two power assemblies are connected through other power assemblies, the number of the fling-cut switches between the two power assemblies which are indirectly connected is greater than 1, and the number of the power assemblies spaced between the two power assemblies which are indirectly connected is greater than or equal to 1. Illustratively, the power assembly M2 is spaced between the power assembly M1 and the power assembly M3 in FIG. 2, and then the power assembly M1 and the power assembly M3 are two power assemblies which are indirectly connected.

The charging device further includes a direct-current bus and a charging terminal, where there may be one or more direct-current buses in the charging device, and one direct-current bus is connected with one charging terminal. One direct-current bus may be directly connected with one power assembly, and the power assembly directly connected with the direct-current bus is referred to as a directly connected power assembly, where the power assembly being directly connected with the direct-current bus means that the power assembly is connected with the direct-current bus and the number of the fling-cut switches between the power assembly and the direct-current bus is 0. Illustratively, the power assembly M1 in FIG. 2 is directly connected with the direct-current bus 1, and then the power assembly M1 is the directly connected power assembly. Any power assembly in the power assembly topology may be taken as the directly connected power assembly to be directly connected with the direct-current bus. The specific position of the direct-current bus may be set based on actual demands.

The power assembly topology may be any type of network topology. The power assembly topology may be considered as a multi-layer network topology, where the concept of a layer is defined by taking the direct-current bus as a basis reference, and the farther the power assembly is from the direct-current bus, the greater the number of layers corresponding to the power assembly. The number of layers of the power assembly may be measured by the number of power assemblies spaced between the power assembly and the direct-current bus, the number of layers of the power assembly is equal to the distance between the power assembly and the directly connected power assembly of the direct-current bus plus 1, and the distance between two power assemblies is measured by the number of fling-cut switches between the two power assemblies. By taking the direct-current bus 1 in FIG. 2 as a basis reference for an example, the power assembly M1 is the directly connected power assembly of the direct-current bus 1, and there is no fling-cut switch between the power assembly M1 and the power assembly M1, then the distance between the power assembly M1 and the power assembly M1 is 0, and the number of layers of the power assembly M1 is 1 when the direct-current bus 1 is taken as the basis reference; there is 1 fling-cut switch between the power assembly M2 and the power assembly M1, then the distance between the power assembly M2 and the power assembly M1 is 1, and the number of layers of the power assembly M2 is 2 when the direct-current bus 1 is taken as the basis reference; and there are 2 fling-cut switches between the power assembly M3 and the power assembly M1, then the distance between the power assembly M3 and the power assembly M1 is 2, and the number of layers of the power assembly M3 is 3 when the direct-current bus 1 is taken as the basis reference. It should be understood that in the power assembly topology, the number of layers of each power assembly may be different when the direct-current buses taken as the basis references are different. For example, if the direct-current bus 2 in FIG. 2 is taken as the basis reference, the number of layers of the power assembly M2 is 1 when the direct-current bus 2 is taken as the basis reference.

The present disclosure may be implemented based on the charging device described in conjunction with the above FIG. 2, which will be described in detail below.

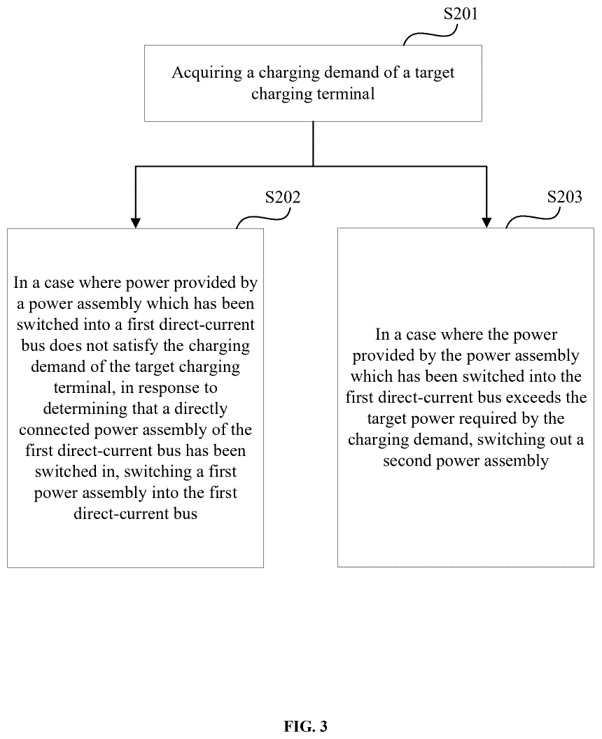

FIG. 3 is a schematic flow diagram of a power distribution method according to an embodiment of the present disclosure, and the method may be applied to the above charging device 101. As shown in FIG. 3, the method includes the following steps.

S201, acquiring a charging demand of a target charging terminal.

Where the target charging terminal is connected with a first direct-current bus, and the first direct-current bus is any direct-current bus in the charging device; with regard to the related meaning of the charging terminal and the direct-current bus, reference may be made to the above description, which will not be described in detail herein.

In an embodiment, demand information of an electric device connected with the target charging terminal may be received by the target charging terminal to acquire the charging demand of the target charging terminal. The demand information of the electric device may contain charging rated power (hereinafter referred to as target power) required for charging the electric device, namely, the charging demand of the target charging terminal includes the target power.

S202, in a case where power provided by a power assembly which has been switched into the first direct-current bus does not satisfy the charging demand of the target charging terminal, in response to determining that a directly connected power assembly of the first direct-current bus has been switched in, switching a first power assembly into the first direct-current bus.

Where the power assembly which has been switched into the first direct-current bus refers to a power assembly which has been distributed to the target charging terminal for use; and the power provided by the power assembly which has been switched into the first direct-current bus is equal to the sum of rated power (hereinafter referred to as the total rated power) of the power assemblies which have been distributed to the target charging terminal for use, namely, the maximum power which may be currently output by the target charging terminal.

The directly connected power assembly of the first direct-current bus refers to a power assembly connected with the first direct-current bus. By taking the direct-current bus 1 in FIG. 2 as the first direct-current bus for an example, the directly connected power assembly of the first direct-current bus refers to the power assembly M1 in FIG. 2.

The first power assembly is a power assembly which has not yet been switched in, which means that the power assembly has not been distributed to any charging terminal for use. The first power assembly is connected to the directly connected power assembly of the first direct-current bus and is closest to the directly connected power assembly of the first direct-current bus. The first power assembly is connected to the directly connected power assembly of the first direct-current bus, which means that electrical connection between the first power assembly and the directly connected power assembly of the first direct-current bus may be established by turning on a controllable fling-cut switch which is currently present.

In an embodiment, the above total rated power may be compared with the above target power to determine whether the power provided by the power assembly which has been switched into the first direct-current bus satisfies the charging demand of the target charging terminal. If the total rated power is less than the target power, it is determined that the charging demand of the target charging terminal is not satisfied; if the total rated power is equal to the target power, it is determined that the charging demand of the target charging terminal is satisfied; and if the total rated power is greater than the target power, it is determined that the charging demand of the target charging terminal is exceeded.

In an embodiment, after it is determined that the power provided by the power assembly which has been switched into the first direct-current bus does not satisfy the charging demand of the target charging terminal, it may be determined whether the directly connected power assembly of the first direct-current bus has been switched; and when the directly connected power assembly of the first direct-current bus has been switched in, based on the distance between the power assemblies in the power assembly topology and the directly connected power assembly of the first direct-current bus, the next layer of power assemblies of the directly connected power assembly of the first direct-current bus may be acquired through traversal, and it is determined whether the next layer of power assemblies all has been switched. If the next layer of power assemblies has not been switched in, one power assembly is selected from the next layer of power assemblies which has not been switched in and obtained through traversal as the first power assembly; and if the next layer of power assemblies all has been switched in, based on the distance between the power assemblies in the power assembly topology and the directly connected power assemblies of the first direct-current bus, it is continued to traverse the next layer to acquire the power assemblies and it is continued to determine whether the power assemblies obtained through traversal all have been switched in and whether the power assemblies can be connected to the first power assembly until the whole power assembly topology is completely traversed, or the power assembly which has not been switched in and can be connected to the directly connected power assemblies of the first direct-current bus is found as the first power assembly. The distribution efficiency can be improved by distributing the power assemblies to the charging terminal by means of layer-by-layer traversal.

Rapid distribution of the power assemblies can be achieved by distributing the power assembly closest to the directly connected power assembly to the charging terminal for use.

In some possible embodiments, in the process of selecting the power assembly from the power assemblies which have not been switched in and are obtained through traversal as the first power assembly, the power assemblies having power greater than or equal to a first power gap may be determined from the power assemblies which have not been switched in and are obtained through traversal, and one power assembly is selected from the power assemblies having the power greater than or equal to the first power gap as the first power assembly, where the first power gap is a power gap between the target power and the total rated power, namely, the power of the first power assembly is greater than or equal to the first power gap. By way of example, assuming that currently there are 3 power assemblies which have not been switched in and are obtained through traversal, which are respectively a power assembly m1, a power assembly m2, and a power assembly m3, the power provided by the power assembly m1, the power assembly m2, and the power assembly m3 is respectively 4 kilowatts, 6 kilowatts, and 8 kilowatts, the total rated power which has been switched into the first direct-current bus is 4 kilowatts, the target power corresponding to the charging demand is 9 kilowatts, and then the first power gap is 5 kilowatts. Since 6 kilowatts and 8 kilowatts are greater than 5 kilowatts, one power assembly is selected from the power assembly m2 and the power assembly m3 as the first power assembly. By preferably selecting and distributing the power assembly having the power greater than the power gap between the required power and the power which has been switched in, the distributed power can be enabled to rapidly meet the charging demand of the charging terminal.

In an embodiment, the power assembly having the power with the smallest absolute value of the difference value with the first power gap in the power assemblies having the power greater than or equal to the first power gap may be taken as the first power assembly, namely, the absolute value of the difference value between the first power assembly and the first power gap is smallest. By taking the power assemblies having the power greater than or equal to the first power gap being the above power assembly m2 and power assembly m3 for an example, since the absolute value of the difference value between 6 kilowatts and 5 kilowatts is 1 kilowatt, and the absolute value of the difference value between 8 kilowatts and 5 kilowatts is 3 kilowatts, the power assembly m2 is preferably selected as the first power assembly. By distributing the power assembly having the power with the smallest absolute value of the difference value with the power gap between the required power and the power which has been switched in, reasonable distribution of the power assembly can be achieved.

In some possible cases, the above first power assembly may be a power assembly which has not been directly connected with a second direct-current bus.

Where the second direct-current bus is another direct-current bus other than the above first direct-current bus. By taking the first direct-current bus being the direct-current bus 1 in FIG. 2 for an example, the second direct-current bus may be the direct-current bus 2 and the direct-current bus 3 in FIG. 2.

In an embodiment, in the above process of determining the first power assembly, if there are a plurality of power assemblies in the next layer which are acquired through traversal and all have not been switched in, one power assembly may be selected from common power assemblies in the plurality of power assemblies of the next layer of power assemblies as the first power assembly, namely, the first power assembly is determined from the power assemblies which are not directly connected power assemblies.

By preferably distributing the power assembly which is not connected with other direct-current buses to the charging terminal for use, the directly connected power assembly which is connected with other direct-current buses can be enabled to be distributed to the charging terminal which is connected with other direct-current buses for use as rapidly as possible.

In an embodiment, after it is determined that the charging demand of the target charging terminal is not satisfied, if the directly connected power assembly of the first direct-current bus has not been switched in, the directly connected power assembly of the first direct-current bus may be switched into the first direct-current bus.

By preferably distributing the directly connected power assembly connected with the direct-current bus to the charging terminal for use, the distribution efficiency of the power assembly can be improved.

In an embodiment, after it is determined that the charging demand of the target charging terminal is not satisfied, if the directly connected power assembly of the first direct-current bus has been switched in, but has not been switched into the first direct-current bus, a disabling identifier is set for the directly connected power assembly of the first direct-current bus.

Where the disabling identifier is used for indicating that the second direct-current bus is prohibited from being connected to the directly connected power assembly of the first direct-current bus. After the disabling identifier is set, the second direct-current bus occupying the directly connected power assembly may be waited to exit the directly connected power assembly. By taking the first direct-current bus being the direct-current bus 1 in FIG. 2 for an example, assuming that the power assembly M1 in FIG. 2 has been switched into the direct-current bus 2, the disabling identifier may be set for the power assembly M1, the direct-current bus 2 is prohibited from using the power assembly M1, and the disabling identifier may be set as: {R: Module1, Bus2}, where R represents disabling, Module1 is the power assembly M1, and Bus2 is the direct-current bus 2.

By setting the disabling identifier for the directly connected power assembly, it can be ensured that the directly connected power assembly can be preferably distributed to the charging terminal connected to the direct-current bus corresponding to the directly connected power assembly for use subsequently.

In an embodiment, after the disabling identifier is set for the directly connected power assembly of the first direct-current bus, if the charging demand of the target charging terminal is not satisfied, it may also be monitored that the second direct-current bus having the disabling identifier switches out the directly connected power assembly of the first direct-current bus, and then the directly connected power assembly of the first direct-current bus is switched into the first direct-current bus. The charging terminal can be charged rapidly by monitoring the switch-out situation of the directly connected power assembly by other direct-current buses and switching the directly connected power assembly into the directly connected direct-current bus in time.

In an embodiment, after one power assembly is switched into the first direct-current bus, assembly information about the power assembly switched into the first direct-current bus may be stored in a cache array.

Where the cache array is used for storing assembly information about all the power assemblies which have been switched in.

In an embodiment, switch-in operation may be executed on the above first power assembly or directly connected power assembly of the first direct-current bus, and whether the switch-in is successful is determined, in a case where the switch-in is successful, assembly information about the power assembly which is switched in may be stored in the cache array.

Where one power assembly may be switched into the first direct-current bus by the following steps: (a1) determining the power assembly switched into the first direct-current bus; (a2) a power-off state; (a3) setting a temporary packet; (a4) powering on; (a5) boosting; (a6) switching in a switch, namely, turning on a fling-cut switch capable of establishing electrical connection between the power assembly to be switched in and the first direct-current bus; (a7) powering off; (a8) clearing an address of the temporary packet; (a9) setting a packet for the purpose of binding the power assembly to be switched in and the first direct-current bus through configuration information; and (a10) notifying the completion of switch-in.

After one power assembly is switched into the direct-current bus, the assembly information about the power assembly which has been switched is saved by the cache array, so that the distribution and management of the power assembly can be achieved.

S203, in a case where the power provided by the power assembly which has been switched into the first direct-current bus exceeds the target power required by the charging demand, switching out a second power assembly.

Where the second power assembly is one power assembly which has been switched into the first direct-current bus, namely, one power assembly which has been distributed to the target charging terminal for use. By switching out the power assembly which has been switched into the charging terminal, reliable management of the power assembly can be achieved.

In some possible cases, the second power assembly may be a power assembly farthest from the directly connected power assembly of the first direct-current bus.

In an embodiment, each power assembly which has been switched into the first direct-current bus may be determined, a distance between each power assembly and the directly connected power assembly of the first direct-current bus may be determined, and the power assembly with the largest distance is determined as the second power assembly.

By preferably switching out the power assembly farthest from the directly connected power assembly, reasonable management of the power assembly can be achieved.

Where in a case where there are a plurality of power assemblies which are farthest from the directly connected power assembly of the first direct-current bus, the power assemblies having power less than or equal to a second power gap may be determined from the power assemblies which are farthest from the directly connected power assembly of the first direct-current bus, and one power assembly is selected from the power assemblies having the power less than or equal to the second power gap as the second power assembly, where the second power gap is a gap between the total rated power and the target power, namely, the power of the second power assembly is less than or equal to the second power gap. By way of example, assuming that there are 3 power assemblies which are farthest from the directly connected power assembly of the first direct-current bus, which are respectively a power assembly m4, a power assembly m5, and a power assembly m6, the power provided by the power assembly m4, the power assembly m5, and the power assembly m6 is respectively 4 kilowatts, 9 kilowatts, and 5 kilowatts, the total rated power which has been switched into the first direct-current bus is 18 kilowatts, and the target power corresponding to the charging demand is 13 kilowatts, the second power gap is 5 kilowatts. Since 4 kilowatts and 5 kilowatts are greater than or equal to 5 kilowatts, one power assembly is selected from the power assembly m4 and the power assembly m6 as the second power assembly.

In an embodiment, the power assembly having the power with the smallest absolute value of the difference value with the second power gap in the power assemblies having the power less than or equal to the second power gap may be taken as the second power assembly, namely, the absolute value of the difference value between the power of the second power assembly and the second power gap is smallest. By taking the power assemblies having the power less than or equal to the second power gap being the power assembly m4 and the power assembly m6 for an example, since the absolute value of the difference value between 4 kilowatts and 5 kilowatts is 1 kilowatt, and the absolute value of the difference value between 5 kilowatts and 5 kilowatts is 0 kilowatt, the power assembly m6 is preferably selected as the second power assembly. By switching out the power assembly having power with the smallest absolute value of the difference value with the power gap between the required power and the power which has been switched in, reasonable distribution of the power assembly can be achieved.

In some possible cases, the second power assembly may be a power assembly which is directly connected with the second direct-current bus.

In an embodiment, it may be determined whether the power assembly which has been switched into the first direct-current bus and is farthest from the directly connected power assembly of the first direct-current bus is connected with the second direct-current bus, and the power assembly connected with the second direct-current bus is determined as the second power assembly.

By preferably switching out other directly connected power assemblies in a bottommost layer, it can be ensured that each directly connected power assembly can be preferably distributed to the charging terminal connected to the direct-current bus corresponding to the directly connected power assembly, so that the directly connected power assembly connected with the direct-current bus can be used by the charging terminal connected with the direct-current bus as rapidly as possible.

In an embodiment, after one power assembly which has been switched into the first direct-current bus is switched out, assembly information about the power assembly which is switched out may be deleted in the cache array.

In an embodiment, switch-out operation may be executed on the above second power assembly, and it is determined whether the switch-out is successful, in a case where the switch-out is successful, the assembly information about the switch-out power assembly may be deleted in the cache array.

Where one power assembly which has been switched into the first direct-current bus may be switched out by the following steps: (b1) marking that the power assembly cannot be used, and executing power-off; (b2) a power-off state; (b3) switching off a switch, namely, turning off one fling-cut switch closest to the power assembly in fling-cut switches for establishing electrical connection between the power assembly and the first direct-current bus; (b4) clearing a packet, namely, releasing a binding relationship between the power assembly which is switched out and the first direct-current bus; and (b5) notifying the completion of exit.

By deleting the assembly information about the power assembly which is switched out in the cache array, the distribution and management of the power assembly can be achieved.

In the embodiment shown in FIG. 3, after the charging demand of the charging terminal connected with the direct-current bus is acquired, switch-in or switch-out of the power assembly is performed according to the charging demand of the charging terminal, the switch-in situation of the power assembly, and the distance between the power assembly and the directly connected power assembly, and the dynamic distribution of the power can be achieved, so that the output power of the charging terminal can meet the charging demand. The power assemblies in the charging device are connected to form the power assembly topology, the fling-cut switch is used for connecting two adjacent power assemblies, the distance between the power assemblies and the directly connected power assembly is measured by the number of fling-cut switches connected between the power assemblies and the directly connected power assembly, and the power assembly closest to the directly connected power assembly is distributed to the charging terminal for use, which is essentially distributing the nearby power assembly to the charging terminal according to the hierarchy of a topology structure formed by the power assemblies, so that the charging terminal may be applicable to the power assembly topology formed by various connection modes, with high applicability.

In an embodiment, if assembly information about the directly connected power assembly is present in the cache array and the directly connected power assembly has not been switched into any direct-current bus in the charging device, or if assembly information about a faulty power assembly is present in the cache array, a third power assembly is switched out.

Where assembly information about the third power assembly is stored in the cache array, and the third power assembly is one power assembly which is connected with an unavailable power assembly and is farthest from the unavailable power assembly, the unavailable power assembly is the directly connected power assembly or the above faulty power assembly which has the assembly information present in the cache array and has not been switched into any direct-current bus, and the faulty power assembly is a power assembly which is faulty and incapable of providing electric energy.

In an embodiment, all the power assemblies connected to a lower layer of the unavailable power assembly may be acquired, it is determined whether assembly information about each power assembly in all the power assemblies is present in the cache array, the assembly information is present in the cache array, one power assembly farthest from the unavailable power assembly is determined as the third power assembly, and switch-out operation is executed on the third power assembly, where reference may be made to the above steps (b1) to (b5) for the specific steps of the switch-out operation.

When the assembly information about the directly connected power assembly is present in the cache array and the power assembly has not been switched into the charging device, it indicates that there is a problem in switching in the directly connected power assembly. By preferably switching out the power assembly which has been switched in and is farthest from the unavailable power assembly, reliable management of the power assembly can be achieved, and ineffective switch-in of the power assembly can be avoided.

In an embodiment, after one power assembly is switched into the first direct-current bus, or one power assembly which has been switched into the first direct-current bus is switched out, the charging terminal connected with the second direct-current bus may also be taken as the target charging terminal, and the above step shown in FIG. 3 is executed to achieve the distribution of power for other charging terminals.

By distributing or switching out only one power assembly to one charging terminal each time, it can be ensured that the charging demand of each charging terminal can be satisfied, and reliable and effective management of the power assembly can be achieved.

When there are a plurality of direct-current buses in the charging device, the dynamic distribution and management of a plurality of power assemblies in the charging device may be achieved by traversing and polling the direct-current buses in the charging device, and switching in or switching out the power assemblies in the charging device according to the solution described above, so that each direct-current bus can be distributed to a suitable and reliable power assembly. The processes of traversing and polling the direct-current buses and switching the power assemblies are described below. The number of the direct-current buses is assumed to be N.

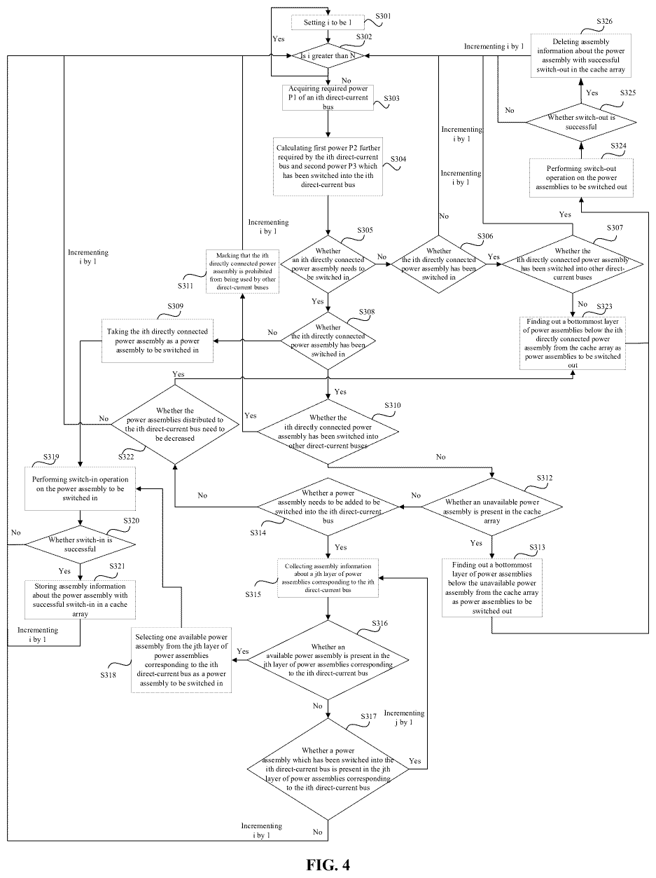

FIG. 4 is a schematic flow diagram of another power distribution method according to an embodiment of the present disclosure, and the method may be applied to the charging device 101 described above. As shown in FIG. 4, the method includes the following steps.

S301, setting i to be 1.

S302, determining whether i is greater than N.

If i is greater than N, it indicates that all the direct-current buses have been traversed and polled, and step S301 is executed to perform the next traversal and polling; and if i is less than or equal to N, it indicates that not all the direct-current buses have been traversed and polled, and step S303 is executed.

S303, acquiring required power P1 of an ith direct-current bus.

Where the required power P1 of the ith direct-current bus is determined based on charging rated power of an electric device connected to an ith charging terminal, and the ith charging terminal refers to a charging terminal connected to the ith direct-current bus.

S304, calculating first power P2 further required by the ith direct-current bus and second power P3 which has been switched into the ith direct-current bus.

Where the second power P3 which has been switched into the ith direct-current bus is equal to the total rated power of the power assemblies which have been switched into the ith direct-current bus; and the first power P2 is equal to the required power P1 minus the second power P3.

S305, determining whether an ith directly connected power assembly needs to be switched in.

Where the ith directly connected power assembly refers to a power assembly which is directly connected with the ith direct-current bus.

It may be determined whether the first power P2 is greater than 0, and if the first power P2 is greater than 0, it is determined that the ith directly connected power assembly needs to be switched in, and step S308 is executed; otherwise, it is determined that the ith directly connected power assembly does not need to be switched in, and step S306 is executed.

S306, determining whether the ith directly connected power assembly has been switched.

It may be queried whether assembly information about the ith directly connected power assembly is present in a cache array, and if the assembly information about the ith directly connected power assembly is present in a cache array, it is determined that the ith directly connected power assembly has been switched in, and step S307 is executed; and if the assembly information about the ith directly connected power assembly is not present in the cache array, it is determined that the ith directly connected power assembly has not been switched in, i is incremented by 1, determination of the demand of the next direct-current bus is performed, and step S302 is executed.

S307, determining whether the ith directly connected power assembly has been switched into other direct-current buses.

Where other direct-current buses refer to direct-current buses other than the ith direct-current bus, namely, direct-current buses which are not the ith direct-current bus.

It may be determined whether the ith directly connected power assembly is switched into other direct-current buses according to a grouping relationship set when the ith directly connected power assembly is switched in, and if the ith directly connected power assembly has been switched into other direct-current buses, i is incremented by 1, and determination of the demand of the next direct-current bus is performed, and step S302 is executed; and if the ith directly connected power assembly has not been switched into other direct-current buses, step S323 is executed.

S308, determining whether the ith directly connected power assembly has been switched.

Where reference may be made to the above step S306 for the determination principle. If the ith directly connected power assembly has been switched in, step S310 is executed; and if the ith directly connected power assembly has not been switched in, step S309 is executed.

S309, taking the ith directly connected power assembly as the power assembly to be switched in, and executing step S319.

S310, determining whether the ith directly connected power assembly has been switched into other direct-current buses.

Where reference may be made to the above step S307 for the determination principle. If the ith directly connected power assembly has been switched into other direct-current buses, step S311 is executed; and if the ith directly connected power assembly has not been switched into other direct-current buses, step S312 is executed.

S311, marking that the ith directly connected power assembly is prohibited from being used by other direct-current buses.

The other direct-current buses herein refer to direct-current buses to which the ith directly connected power assembly is switched in; and
i is incremented by 1, and determination of the demand of the next direct-current bus is performed to return to execute step S302.

S312, determining whether an unavailable power assembly is present in the cache array.

It may be determined whether assembly information about the ith directly connected power assembly or assembly information about a faulty power assembly is present in the cache array, and if the assembly information about the ith directly connected power assembly or the assembly information about the faulty power assembly is present in the cache array, it is determined that an unavailable power assembly is present in the cache array, and step S313 is executed; otherwise, it is determined that the unavailable power assembly is not present in the cache array, and step S314 is executed.

S313, finding out a bottommost layer of power assemblies below the unavailable power assembly from the cache array as power assemblies to be switched out.

Where the bottommost layer of power assemblies below the unavailable power assembly refer to power assemblies which have established electrical connection with the unavailable power assembly and are farthest from the unavailable power assembly.

S314, determining whether a power assembly needs to be added to be switched into the ith direct-current bus.

If the second power P3 which has been switched into the ith direct-current bus is less than the required power P1, it is determined that addition is needed, and step S315 is executed; and if the second power P3 which has been switched into the ith direct-current bus is greater than the required power P1, addition is not needed, and step S322 is executed.

S315, collecting assembly information about a jth layer of power assemblies corresponding to the ith direct-current bus.

Where j has an initial value of 1.

S316, determining whether an available power assembly is present in the jth layer of power assemblies corresponding to the ith direct-current bus.

It may be determined whether the assembly information about the jth layer of power assemblies corresponding to the ith direct-current bus is present in the cache array, and if the assembly information about the jth layer of power assemblies corresponding to any one of the ith direct-current buses is not present in the cache array, it is determined that an available power assembly is present in the jth layer of power assemblies corresponding to the ith direct-current bus, switch-in of the power assembly may be performed, and step S318 is executed; otherwise, it is determined that the available power assembly is not present in the jth layer of power assemblies corresponding to the ith direct-current bus, the power assembly needs to be found in the next layer, and step S317 is executed.

S317, determining whether a power assembly which has been switched into the ith direct-current bus is present in the jth layer of power assemblies corresponding to the ith direct-current bus.

If the power assembly which has been switched into the ith direct-current bus is not present in the jth layer of power assemblies, it indicates that electrical connection between the further next layer of power assemblies and the directly connected power assembly cannot be established, i is incremented by 1, and determination of the demand of the next direct-current bus is performed to return to execute step S302; and if a power assembly which has been switched into the ith direct-current bus is present in the jth layer of power assemblies, the power assembly may be found in the next layer, and i is incremented by 1 to return to execute step S315.

S318, selecting one available power assembly from the jth layer of power assemblies corresponding to the ith direct-current bus as a power assembly to be switched in.

S319, performing switch-in operation on the power assembly to be switched in.

S320, determining whether switch-in is successful.

If the switch-in is successful, step S321 is executed; and if the switch-in is not successful, step S302 is executed.

S321, storing assembly information about the power assembly with successful switch-in in a cache array.

Where i is incremented by 1, determination of the demand of the next direct-current bus is performed, and step S302 is executed.

S322, determining whether the power assemblies distributed to the ith direct-current bus need to be decreased.

If the second power P3 which has been switched into the ith direct-current bus is less than the required power P1, it is determined that there is no need to decrease, i is incremented by 1, determination of the demand of the next direct-current bus is performed, and step S302 is executed; and if the second power P3 which has been switched into the ith direct-current bus is greater than the required power P1, it is determined that decrease is needed, and step S323 is executed.

S323, finding out a bottommost layer of power assemblies below the ith directly connected power assembly from the cache array as power assemblies to be switched out.

Where the bottommost layer of power assemblies below the ith directly connected power assembly refer to power assemblies which have established electrical connection with the ith directly connected power assembly and are farthest from the ith directly connected power assembly.

S324, performing switch-out operation on the power assemblies to be switched out.

S325, determining whether switch-out is successful.

If the switch-out is successful, step S326 is executed; and if the switch-out is not successful, step S302 is executed.

S326, deleting assembly information about the power assembly with successful switch-out in the cache array.

Where i is incremented by 1, and determination of the demand of the next direct-current bus is performed to return to execute S302.

The method of the present disclosure is described above, and an apparatus of the present disclosure is described below.

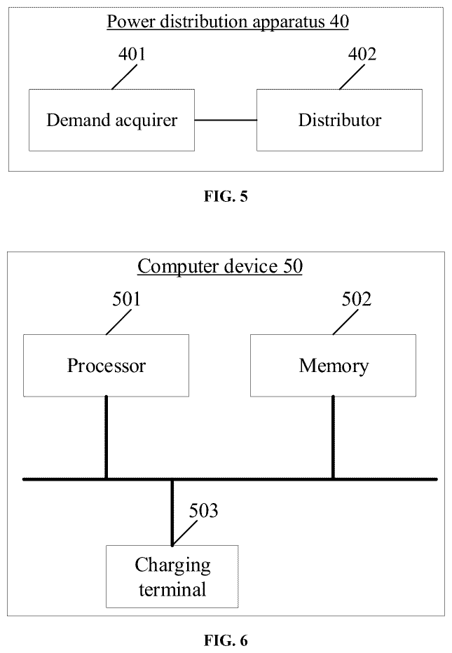

FIG. 5 is a schematic structural diagram of a power distribution apparatus according to an embodiment of the present disclosure, which is applied to a charging device 101; and the power distribution apparatus 40 includes:
a demand acquirer 401, used for acquiring a charging demand of a target charging terminal, the target charging terminal being connected with a first direct-current bus, and the first direct-current bus being any direct-current bus in the charging device; and
a distributor 402, used for: in a case where power provided by a power assembly which has been switched into the first direct-current bus does not satisfy the charging demand, if a directly connected power assembly of the first direct-current bus has been switched in, switching a first power assembly into the first direct-current bus, the directly connected power assembly being directly connected with the first direct-current bus, the first power assembly being one power assembly which has not been switched in, the first power assembly being capable of being connected to the directly connected power assembly and being closest to the directly connected power assembly, and a distance between the power assemblies and the directly connected power assembly being measured by the number of fling-cut switches connected between the power assemblies and the directly connected power assembly.

In one embodiment, the above distributor 402 is further used for: based on the distance between the plurality of power assemblies and the directly connected power assembly, traversing the power assembly topology layer by layer by starting from a layer of power assemblies closest to the directly connected power assembly; and determining the first power assembly from the power assemblies which have not been switched in and obtained through traversal.

In one embodiment, power of the first power assembly is greater than or equal to a first power gap, and the first power gap is a power gap between target power required by the charging demand and power provided by the power assembly which has been switched into the first direct-current bus.

In one embodiment, an absolute value of a difference value between the power of the first power assembly and the first power gap is smallest.

In one embodiment, the first power assembly is a power assembly which has not been directly connected with a second direct-current bus, and the second direct-current bus is another direct-current bus other than the first direct-current bus in the charging device.

In one embodiment, the above distributor 402 is further used for: in a case where power provided by a power assembly which has been switched into the first direct-current bus does not satisfy the charging demand, if the directly connected power assembly has not been switched in, switching the directly connected power assembly into the first direct-current bus.

In one embodiment, the above distributor 402 is further used for: in a case where power provided by a power assembly which has been switched into the first direct-current bus does not satisfy the charging demand, if the directly connected power assembly has been switched in, but has not been switched into the first direct-current bus, setting a disabling identifier for the directly connected power assembly, the disabling identifier being used for indicating that the second direct-current bus is prohibited from being connected to the directly connected power assembly, and the second direct-current bus being another direct-current bus other than the first direct-current bus in the charging device.

In one embodiment, the above distributor 402 is further used for: in a case where the charging demand is not satisfied, monitoring that the second direct-current bus having the disabling identifier switches out the directly connected power assembly; and switching the directly connected power assembly into the first direct-current bus.

In one embodiment, the above distributor 402 is further used for: after one power assembly is switched into the first direct-current bus, storing assembly information about the power assembly switched into the first direct-current bus in a cache array, the cache array being used for storing assembly information about all the power assemblies which have been switched in.

In one embodiment, the above distributor 402 is further used for: in a case where the power provided by the power assembly which has been switched into the first direct-current bus exceeds the target power required by the charging demand, switching out a second power assembly, the second power assembly being one power assembly which has been switched into the first direct-current bus.

In one embodiment, the second power assembly is a power assembly farthest from the directly connected power assembly.

In one embodiment, the second power assembly is a power assembly directly connected with the second direct-current bus, the second direct-current bus being another direct-current bus other than the first direct-current bus in the charging device.

In one embodiment, power of the second power assembly is less than or equal to a second power gap, the second power gap being a power gap between the power provided by the power assembly which has been switched into the first direct-current bus and the target power required by the charging demand.

In one embodiment, an absolute value of a difference value between the power of the second power assembly and the second power gap is smallest.

In one embodiment, the above distributor 402 is further used for: after switching out one power assembly which has been switched into the first direct-current bus, deleting assembly information about the power assembly which is switched out in the cache array, the cache array being used for storing assembly information about all the power assemblies which have been switched in.

In one embodiment, the above distributor 402 is further used for: if assembly information about the directly connected power assembly is present in the cache array and the directly connected power assembly has not been switched into any direct-current bus in the charging device, or if assembly information about a faulty power assembly is present in the cache array, switching out a third power assembly, the cache array being used for storing assembly information about all the power assemblies which have been switched in, assembly information about the third power assembly being stored in the cache array, the third power assembly being one power assembly which is connected with an unavailable power assembly and is farthest from the unavailable power assembly, and the unavailable power assembly being the directly connected power assembly or the faulty power assembly.

In one embodiment, the first direct-current bus is an ith direct-current bus in the charging device, i being a positive integer; and the above demand acquirer 401 is further used for: after one power assembly is switched into the ith direct-current bus or one power assembly which has been switched into the ith direct-current bus is switched out, acquiring a charging demand of a charging terminal connected with an (i+1)th direct-current bus, where i is greater than or equal to 1 and i is less than or equal to (N−1), and N is a total number of direct-current buses in the charging device.

It should be noted that reference may be made to the description of the above method embodiments for the content which is not mentioned in the embodiments corresponding to FIG. 5, which will not be described in detail herein.

For the above apparatus, after the charging demand of the charging terminal connected with the direct-current bus is acquired, switch-in or switch-out of the power assembly is performed according to the charging demand of the charging terminal, the switch-in situation of the power assembly, and the distance between the power assembly and the directly connected power assembly, and the dynamic distribution of the power can be achieved, so that the output power of the charging terminal can meet the charging demand. The power assemblies in the charging device are connected to form the power assembly topology, the fling-cut switch is used for connecting two adjacent power assemblies, the distance between the power assemblies and the directly connected power assembly is measured by the number of fling-cut switches connected between the power assemblies and the directly connected power assembly, and the power assembly closest to the directly connected power assembly is distributed to the charging terminal for use, which is essentially distributing the nearby power assembly to the charging terminal according to the hierarchy of a topology structure formed by the power assemblies, so that the charging terminal not only has the output power which can satisfy the charging demand, but also can be applicable to the power assembly topology formed by various connection modes, with high applicability.

FIG. 6 is a schematic structural diagram of a computer device according to an embodiment of the present disclosure, and the computer device may be the charging device 101 described above. The computer device 50 includes a processor 501, a memory 502, and a charging terminal 503. The memory 502 is connected to the processor 501, for example, connected to the processor 501 through a bus; and the charging terminal 503 is connected to the processor 501, for example, connected to the processor 501 through a direct-current bus.

The processor 501 is configured to support the computer device 50 in executing the corresponding functions in the method in the above method embodiments. The processor 501 may be a central processing unit (CPU), a network processor (NP), a hardware chip, or any combination thereof. The above hardware chip may be an application specific integrated circuit (ASIC), a programmable logic device (PLD), or a combination thereof. The above PLD may be a complex programmable logic device (CPLD), a field-programmable gate array (FPGA), generic array logic (GAL), or any combination thereof.

The memory 502 is used for storing program codes and the like. The memory 502 may include a volatile memory (VM), such as a random access memory (RAM); the memory 502 may further include a non-volatile memory (NVM), such as a read-only memory (ROM), a flash memory, a hard disk drive (HDD), or a solid-state drive (SSD); and the memory 502 may further include a combination of the memories of the types described above.

The charging terminal 503 is used for acquiring a charging demand.

The processor 501 may call the program codes to execute the following operation:
acquiring a charging demand of a target charging terminal, where the target charging terminal is connected with a first direct-current bus, and the first direct-current bus is any direct-current bus in the charging device; and
in a case where power provided by a power assembly which has been switched into the first direct-current bus does not satisfy the charging demand, in response to determining that a directly connected power assembly of the first direct-current bus has been switched in, switching a first power assembly into the first direct-current bus, wherein the directly connected power assembly is directly connected with the first direct-current bus, the first power assembly is a power assembly which has not yet been switched in, the first power assembly is connected to the directly connected power assembly and is a power assembly which has a smallest distance to the directly connected power assembly, and a distance between the plurality of power assemblies and the directly connected power assembly is measured by the number of fling-cut switches connected between the plurality of power assemblies and the directly connected power assembly.

An embodiment of the present disclosure further provides a non-transitory computer-readable storage medium having a computer program stored thereon, where the computer program includes program instructions which, when executed by a computer, cause the computer to execute the method according to the above embodiments.

It will be understood by those ordinarily skilled in the art that the implementation of all or part of the flow in the methods of the embodiments described above may be completed by a computer program instructing related hardware, the program may be stored in the computer-readable storage medium, and the program, when executed, may include the flow of the embodiments of the methods described above, where the storage medium may be a magnetic disk, a compact disk, a read-only memory (ROM), or a random access memory (RAM), and the like.

The above disclosure is merely preferred embodiments of the present disclosure, and of course, the scope of rights of the present disclosure cannot be limited by these embodiments. Therefore, the equivalent changes made according to the claims of the present disclosure still fall within the scope covered by the present disclosure.

What is claimed is:

1. A power distribution method, applied to a charging device, the method comprising:
acquiring a charging demand of a target charging terminal, wherein the target charging terminal is connected with a first direct-current bus, and the first direct-current bus is any direct-current bus in the charging device;
wherein the charging device comprises a plurality of power assemblies, the plurality of power assemblies are connected to form a power assembly topology, a fling-cut switch is used for connecting two adjacent power assemblies, and some or all of the plurality of power assemblies are connected with the first direct-current bus in the charging device; and
in a case where power provided by an existing power assembly which has been switched into the first direct-current bus does not satisfy the charging demand, in response to determining that a directly connected power assembly of the first direct-current bus has been switched in, switching a first power assembly into the first direct-current bus, wherein the directly connected power assembly is directly connected with the first direct-current bus, the first power assembly is a power assembly which has not yet been switched in, the first power assembly is connected to the directly connected power assembly and is a power assembly which has a smallest distance to the directly connected power assembly, and a distance between the plurality of power assemblies and the directly connected power assembly is measured by the number of fling-cut switches connected between the plurality of power assemblies and the directly connected power assembly.

2. The method according to claim 1, wherein before switching a first power assembly into the first direct-current bus, the method further comprises:
traversing, based on the distance between the plurality of power assemblies and the directly connected power assembly, the power assembly topology in a layer-by-layer manner, starting from a layer of power assemblies closest to the directly connected power assembly; and
determining the first power assembly from the power assemblies that have not yet been switched in and are obtained through the traversing.

3. The method according to claim 2, wherein a power output of the first power assembly is greater than or equal to a first power gap, and the first power gap is a power gap between a target power required to satisfy the charging demand and a power output provided by the existing power assembly that has been switched into the first direct-current bus.

4. The method according to claim 3, wherein an absolute value of a difference between the power output of the first power assembly and the first power gap is smallest.

5. The method according to claim 1, wherein the first power assembly is a power assembly that is not directly connected to a second direct-current bus, and the second direct-current bus is another direct-current bus other than the first direct-current bus in the charging device.

6. The method according to claim 1, further comprising:
in a case where the charging demand is not satisfied, in response to determining that the directly connected power assembly has not yet been switched into the first direct-current bus, switching the directly connected power assembly into the first direct-current bus.

7. The method according to claim 1, further comprising:
in a case where the charging demand is not satisfied, in response to determining that the directly connected power assembly has been switched in but has not been switched into the first direct-current bus, setting a disabling identifier for the directly connected power assembly, wherein the disabling identifier is used for indicating that the second direct-current bus is prohibited from being connected to the directly connected power assembly, and wherein the second direct-current bus is another direct-current bus other than the first direct-current bus in the charging device.

8. The method according to claim 7, wherein after setting the disabling identifier for the directly connected power assembly, the method further comprises:
in a case where the charging demand is not satisfied, monitoring whether the second direct-current bus having the disabling identifier has switches out the directly connected power assembly; and
in response to the switch-out, switching the directly connected power assembly into the first direct-current bus.

9. The method according to claim 1, further comprising:
after a power assembly is switched into the first direct-current bus, storing assembly information of the power assembly switched into the first direct-current bus in a cache array, wherein the cache array is used for storing assembly information of all the power assemblies that have been switched into the first direct-current bus.

10. The method according to claim 1, further comprising:
in a case where the power provided by the power assembly which has been switched into the first direct-current bus exceeds a target power required to satisfy the charging demand, switching out a second power assembly, wherein the second power assembly is a power assembly that has been switched into the first direct-current bus.

11. The method according to claim 10, wherein the second power assembly is a power assembly that has a greatest distance from the directly connected power assembly.

12. The method according to claim 11, wherein the second power assembly is a power assembly that is directly connected to the second direct-current bus, and the second direct-current bus is another direct-current bus other than the first direct-current bus in the charging device.

13. The method according to claim 11, wherein a power output of the second power assembly is less than or equal to a second power gap, wherein the second power gap is a power gap between the power provided by the existing power assembly that has been switched into the first direct-current bus and the target power required to satisfy the charging demand.

14. The method according to claim 13, wherein an absolute value of a difference between the power output of the second power assembly and the second power gap is smallest.

15. The method according to claim 10, further comprising:
after switching out the power assembly which has been switched into the first direct-current bus, deleting assembly information of the power assembly which is switched out in the cache array, wherein the cache array is used for storing assembly information of all the power assemblies that have been switched into the first direct-current bus.

16. The method according to claim 1, further comprising:
in response to determining that assembly information of the directly connected power assembly is present in a cache array and the directly connected power assembly has not been switched into any direct-current bus in the charging device, or assembly information of a faulty power assembly is present in the cache array, switching out a third power assembly, wherein the cache array is used for storing assembly information of all the power assemblies that have been switched into the first direct-current bus, assembly information of the third power assembly is stored in the cache array, the third power assembly is a power assembly that is connected with an unavailable power assembly and has a greatest distance from the unavailable power assembly, and the unavailable power assembly is the directly connected power assembly or the faulty power assembly.

17. The method according to claim 1, wherein the first direct-current bus is an ith direct-current bus in the charging device, i being a positive integer; and
the method further comprises:
after a power assembly is switched into the ith direct-current bus or a power assembly that has been switched into the ith direct-current bus is switched out, acquiring a charging demand of a charging terminal connected with an (i+1)th direct-current bus, wherein i is greater than or equal to 1 and less than or equal to (N−1), and N is a total number of direct-current buses in the charging device.

18. A non-transitory computer-readable storage medium having a computer program stored thereon, wherein the computer program comprises program instructions which, when executed by a processor, cause the processor to perform acts comprising:
acquiring a charging demand of a target charging terminal, wherein the target charging terminal is connected with a first direct-current bus, and the first direct-current bus is any direct-current bus in a charging device;
wherein the charging device comprises a plurality of power assemblies, the plurality of power assemblies are connected to form a power assembly topology, a fling-cut switch is used for connecting two adjacent power assemblies, and some or all of the plurality of power assemblies are connected with the first direct-current bus in the charging device; and
in a case where power provided by an existing power assembly which has been switched into the first direct-current bus does not satisfy the charging demand, in response to determining that a directly connected power assembly of the first direct-current bus has been switched in, switching a first power assembly into the first direct-current bus, wherein the directly connected power assembly is directly connected with the first direct-current bus, the first power assembly is a power assembly which has not yet been switched in, the first power assembly is connected to the directly connected power assembly and is a power assembly which has a smallest distance to the directly connected power assembly, and a distance between the plurality of power assemblies and the directly connected power assembly is measured by the number of fling-cut switches connected between the plurality of power assemblies and the directly connected power assembly.

19. A charging device, comprising a plurality of power assemblies, wherein the plurality of power assemblies are connected to form a power assembly topology, a fling-cut switch is used to connect two adjacent power assemblies, and some or all of the plurality of power assemblies are connected with a direct-current bus in the charging device, and wherein the charging device is configured to perform acts comprising:
acquiring a charging demand of a target charging terminal, wherein the target charging terminal is connected with a first direct-current bus, and the first direct-current bus is any direct-current bus in a charging device; and
in a case where power provided by an existing power assembly which has been switched into the first direct-current bus does not satisfy the charging demand, in response to determining that a directly connected power assembly of the first direct-current bus has been switched in, switching a first power assembly into the first direct-current bus, wherein the directly connected power assembly is directly connected with the first direct-current bus, the first power assembly is a power assembly which has not yet been switched in, the first power assembly is connected to the directly connected power assembly and is a power assembly which has a smallest distance to the directly connected power assembly, and a distance between the plurality of power assemblies and the directly connected power assembly is measured by the number of fling-cut switches connected between the plurality of power assemblies and the directly connected power assembly.
